(19) United States
(12) Patent Application Publication
(10) Pub. No.: US 2015/0207251 A1
(43) Pub. Date: Jul. 23, 2015

(54) CARD CONNECTOR WITH IMPROVED CONTACTS

(71) Applicant: FOXCONN INTERCONNECT TECHNOLOGY LIMITED, Grand Cayman (KY)

(72) Inventors: DING-BING FAN, Kunshan (CN); MING-QIU HAN, Kunshan (CN); JI-CHAO WANG, Kunshan (CN); GUO-HUA ZHANG, Kunshan (CN); QI-SHENG ZHENG, Kunshan (CN)

(21) Appl. No.: 14/604,640

(22) Filed: Jan. 23, 2015

(30) Foreign Application Priority Data
Jan. 23, 2014 (CN) 201420041055.2

(51) Int. Cl. H01R 12/72

(52) U.S. Cl. CPC H01R 12/721

(57) ABSTRACT

A card connector comprises an insulative housing, a plurality of contacts received in the insulative housing and a metallic cover covering the insulative housing. The contact includes a retaining portion, an extending portion horizontally and forwardly extending from the retaining portion, a connecting portion downwardly and forwardly aslant extending from the extending portion, a floating portion downwardly from the connecting portion and a contacting portion further downwardly extending from the floating portion. There are two bending points on linking portions of the connecting portion connecting with the floating portion and the extending portion, respectively. By such arrangement, when the electrical card is inserted, the contact can rotate about the two bending points in turn, that can improve an elasticity of the contact.

### BACKGROUND OF THE INVENTION

1. Field of the Invention

The present invention relates to card connectors.

2. Description of Related Art

A card connector disclosed in Taiwan Patent No. TW M397629, issued on Feb. 1, 2011, is a related connector. The card connector has an insulative housing, a plurality of contacts received in the insulative housing and a metallic cover covering the insulative housing, the contact is formed with a retention portion received in the insulative housing, a licking portion extending forwardly from the retention portion and a contacting portion extending forwardly from the linking portion. When the electrical card is inserted, the electrical card pushes the contacting portions, and the contacting portions rotate about a bending point between the retention portion and the linking portion, which may cause the contact to permanent deform after a long using.

Hence, an improved card connector is desired to overcome the above problems.

### BRIEF SUMMARY OF THE INVENTION

According to one aspect of the present invention, a card connector, adapted for electrically connecting an electrical card, comprises an insulative housing; a metallic cover covering the insulative housing; and a plurality of contacts received in the insulative housing. The contacts have a first contact group with a plurality of first contacts, the first contact has a first retaining portion, a first extending portion horizontally and forwardly extending from the first retaining portion, a first connecting portion downwardly and forwardly aslant extending from the first extending portion, a first floating portion downwardly from the first connecting portion and a first contacting portion further downwardly extending from the first floating portion. The first contacting portion is formed with a forwardly protruding arch shape; a first bending point is defined on a linking portion of the first floating portion and the first connecting portion, and a second bending point is defined on another linking portion of the first connecting portion and the first extending portion. When the first contacting portion is pushed backwardly, the first floating portion deflects about the first and the second bending point in turn.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

FIG. 1 is an assembled, perspective view of a card connector according to the present invention;

FIG. 2 is a partial exploded, perspective view of the card connector according to the present invention;

FIG. 3 is an exploded, perspective view of the card connector according to the present invention;

FIG. 4 is similar with FIG. 3, but taken from another side;

FIG. 5 is an assembled, perspective view of a contact modular of the card connector according to the present invention;

FIG. 6 is similar with FIG. 5, but taken from another side;

FIG. 7 is a vertical cross-sectional view to show the deflected contact to contact the detect pin of one additional contact;

FIG. 8 is a horizontal cross-sectional view to show that additional contacts are engaged within corresponding notches of the one type electronic card;

FIG. 9 is another vertical cross-sectional view to show the detect pin of one additional contact contacts the elastic arm of the cover.

FIG. 10 is another horizontal cross-sectional view to show the detect pin of one additional contact contacts the cover during mating with another type electronic card without notches thereof.

### DETAILED DESCRIPTION OF THE PREFERRED EMBODIMENTS

In the following description, numerous specific details are set fourth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

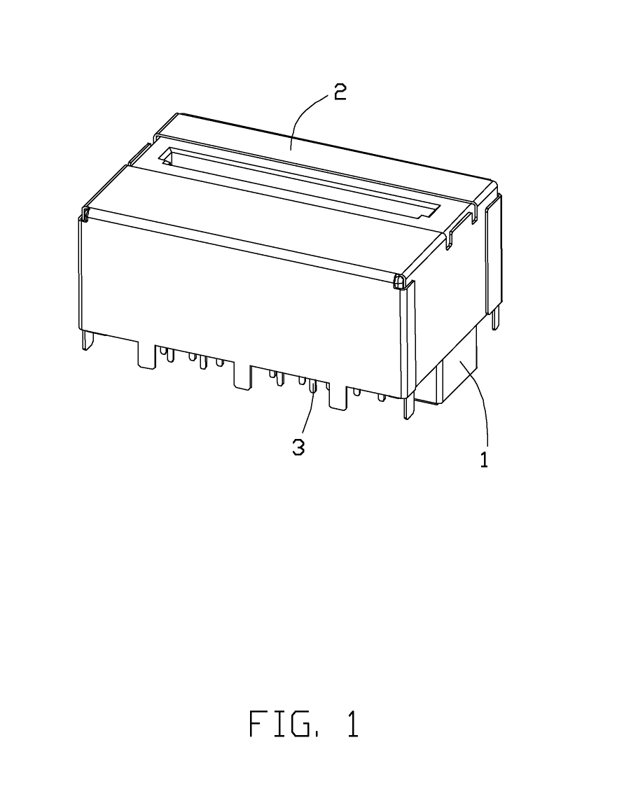

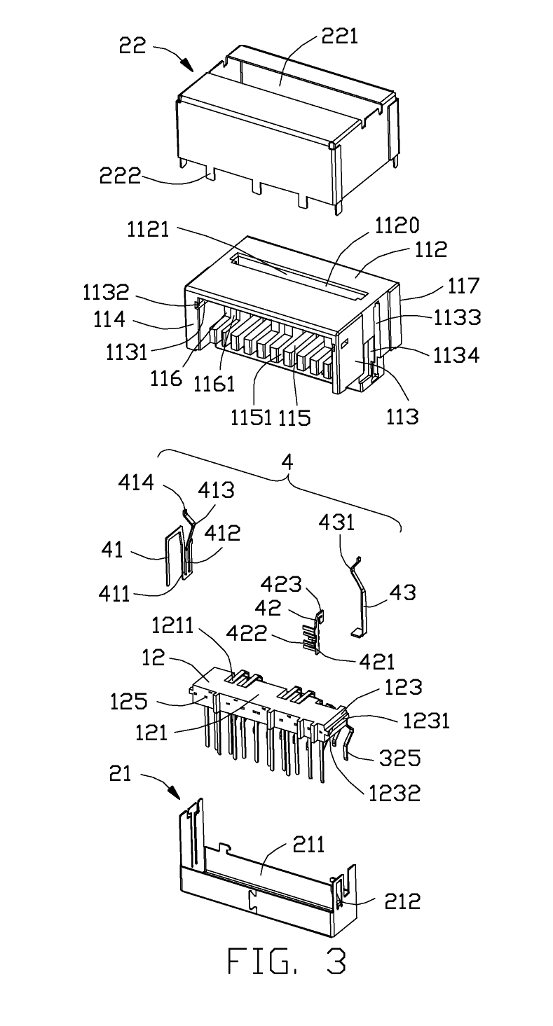

Referring to FIGS. 1 and 3, the card connector according to the present invention comprises an insulative housing 1, a contact module 3 received in the insulative housing 1, additional contacts 4 and a metallic cover 2 covering the insulative housing 1.

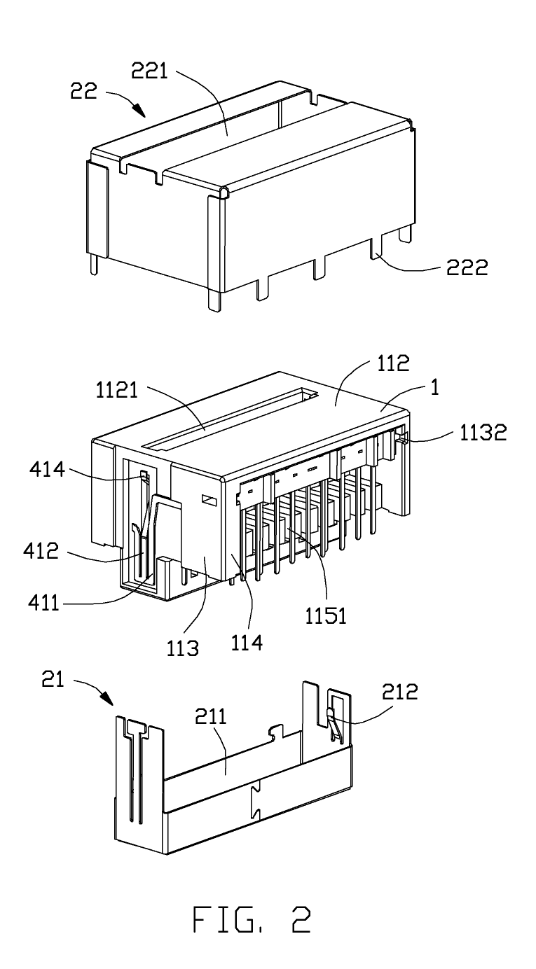

Referring to FIGS. 2-5, the insulative housing 1 is a rectangular shape, has a bottom wall 111, a top wall 112 opposite to the bottom wall 111, two sidewalls 113 connecting the bottom wall 111 and the top wall 112, a rear wall 114, a front wall 117 and a linking wall 116 disposed between the front wall 117 and the rear wall 114 and connecting the top wall 113 and the bottom wall 111.

The front wall 117, the bottom wall 111, the two sidewalls 113 and the linking wall 116 define a receiving cavity 1120 for receiving an electrical card (not shown). The receiving cavity 1120 defines an opening 1121 on the top wall 112. The insulative housing 1 has a front mounting wall 118 in front of the bottom wall 111 and a rear mounting wall 115 in back of the bottom wall 111, and the front mounting wall 118 and the rear mounting wall 115 have a same height, which is higher than the bottom wall 111. The rear wall 114 has a assembling room 1141 recessed backwardly. The assembling room 1141 is defined by the top wall 112, the two sidewalls 113, the rear mounting wall 115 and the linking wall 116.

The linking wall 116 divides the assembling room 1141 and the receiving cavity 1120. The linking wall 116 has a plurality of through slots 1161, which communicate with the receiving cavity 1120 and are arranged along a width direction of the card connector. The rear mounting wall 115 has a plurality of retaining/receiving slots 1151 which are downwardly through the rear mounting wall 115 and corresponds to the slots 1161. Each of the two sidewalls 113 defines a recess 1131 extending along a front to back direction on a top of an inner side thereof, and a latching slot 1132 behind the recess 1131.

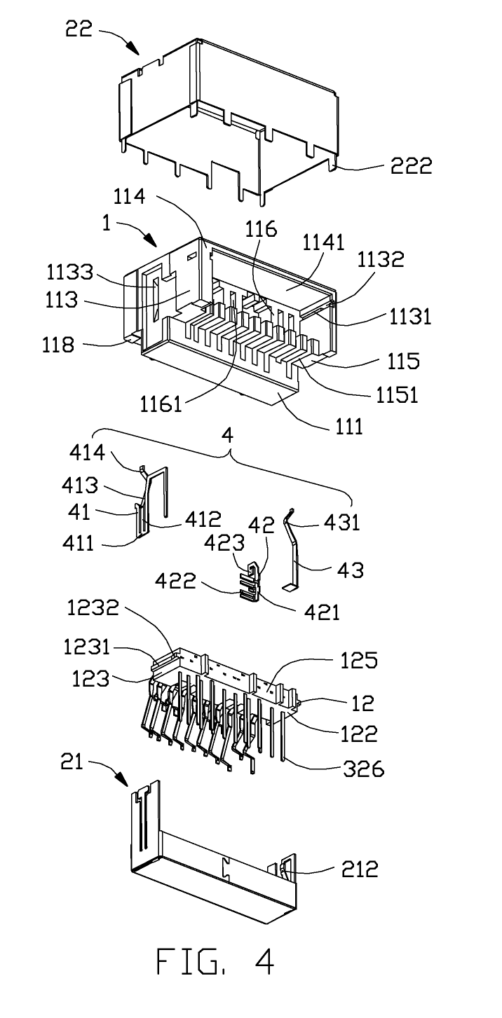

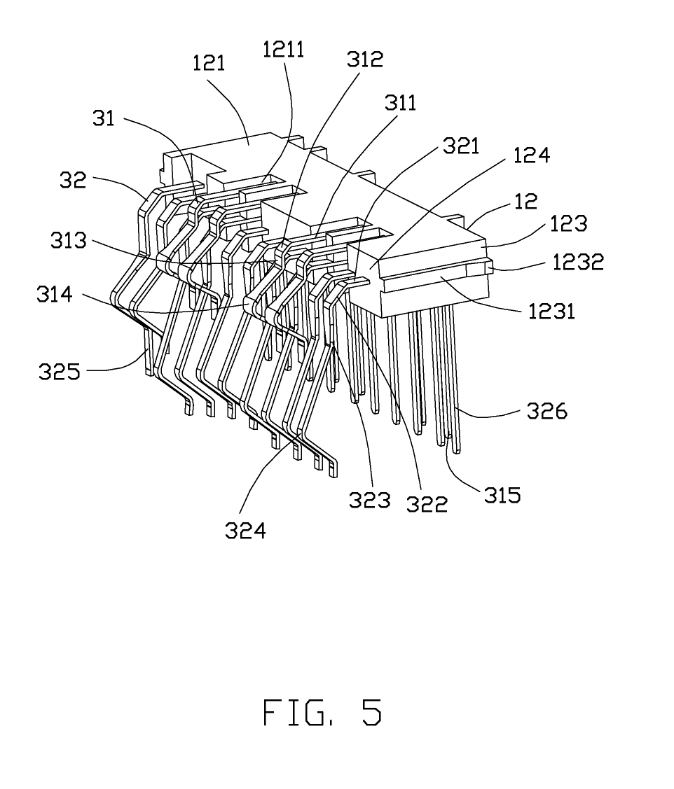

Referring to FIGS. 4-5, the contact modular 3 is assembled into the assembling room 1141 from a rear side, and comprises an insulative mass 12 and contacts, the insulative mass 12 defines a top face 121, a bottom face 122, two end faces 123 connecting the top face 121 and the bottom face 1222, a front face 124 and a rear face 125. The insulative mass 12 has a plurality of gaps 1211 passing through the top face 121, the bottom face 122 and the front face 124 on a front side thereof. The end face 123 is formed with a plurality of ribs 1231 extending along the front-to-back direction and a latching portion 1232 behind the ribs 1231. The ribs 1231 are received in the recess 1131 of the insulative housing 1, and the latching portion 1232 latches with the latching slot 1132 to limit the insulative mass 12 to over forwardly move.

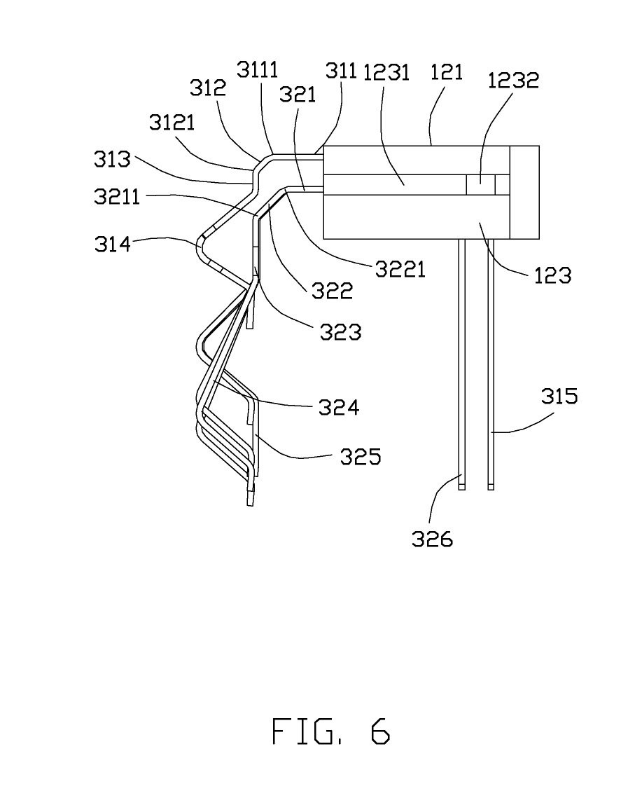

Referring to FIGS. 5-6, the contacts has a first contact group including a plurality of first contacts 31, and a second contact group including a plurality of second contacts 32. The second contact group is used to electrically connect with a SD (Secure Digital Memory) card solely, and to electrically connect with a MMC (Multi Media) card together with the first contact group.

The first contact 31 comprises a first retaining portion (not shown) in the insulative mass 12, a first extending portion 311 horizontally and forwardly extending from the first retaining portion into the gap 1211, a first connecting portion 312 downwardly and forwardly aslant extending from the first extending portion 311, a first floating portion 313 vertically and downwardly from the first connecting portion 312 and a first contacting portion 314 further downwardly extending from the first floating portion 313.

The second contact 32 comprises a second retaining portion (not shown) in the insulative mass 12, a second extending portion 321 horizontally and forwardly extending from the second retaining portion, a second connecting portion 322 downwardly and forwardly aslant extending from the second extending portion 321, a second floating portion 323 vertically and downwardly from the second connecting portion 322 and a second contacting portion 324 further downwardly extending from the second floating portion 323. The contact 32 on the right further has a free end 325 extending downwardly from the second contacting portion 324.

Observed from a side view, the first contacting portion 314 is higher than the second contacting portion 324, and both have a forwardly protruding arch shape. The first retaining portions (not shown) are arranged in an upper row in the insulative mass 12, and the second retaining portion (not shown) are arranged in a lower row. The first contacts 31 and the second contacts 32 further has first soldering tails 315 and second soldering tails 326 extending from another ends of the first and the second retaining portions respectively, and out off the insulative mass 12. Referring to FIG. 3-4, the contacts are received in the slots 1161 by though the retaining slots 1151, the first contacting portions 314 and the second contacting portions 324 are exposed in the receiving cavity 1120, and the first soldering tails 315 and the second soldering tails 326 are separately received in the retaining slots 1151.

A first bending point 3121 is defined on a linking portion linking the first floating portion 313 and the first connecting portion 312, and a second bending point 3111 is defined on a linking portion linking the first connecting portion 312 and the first extending portion 311. A third bending point 3211 is defined on a linking portion linking the second floating portion 323 and the second connecting portion 322, and a fourth bending point 3221 is defined on a linking portion linking the second connecting portion 322 and the second extending portion 321.

When the electrical card is inserted into the receiving cavity 1120, the first contacting portion 314 deflects rearward for being pressed by a pushing force vertical to an insertion direction, and bring the first floating portion 313 deflect rearward about the first bending point 3121, then when the first floating portion 313 deflects a certain position, will bring the first connecting portion 312 deflects rearward about the second bending point 3111, so the first contact 31 has an excellent elasticity by this two processes rotation.

When the other electrical card pushes the second contacting portion 324, the second contacting portion 324 deflects rearward and bring the second floating portion 323 deflect rearward about the third bending point 3211, then when the second floating portion 323 deflects a certain position, will bring the second connecting portion 322 deflects rearward about the fourth bending point 3221, by this two rotations, the second contact 32 also has an excellent elasticity. This arrangement can prevent the contacts 31, 32 from over deforming when merely rotate about one point. The metallic cover 2 has a lower cover 21 assembled to the insulative housing 1 from a bottom side and an upper cover 22 assembled to the insulative housing 1 from a top side. The lower cover 21 has a space 211 for receiving the bottom wall 111 of the insulative housing 1, and elastic arms 212. The upper cover 22 surrounds the insulative housing 1, and defines window 221 corresponding to the opening 1121 on a top thereof. The upper cover 22 further has a plurality of soldering portions 222 extending from lateral sides thereof to solder the card connector to a printed circuit board (not shown).

Referring to FIGS. 2-3, each of the two sidewalls 113 of the insulative housing 1 defines a groove 1133, and one sidewalls 113 further has a notch 1134 behind the groove 1133.

The additional contacts 4 comprise a first detect pin 41 and a second detect pin 42 set on the two sidewalls 113, the first detect pin 41 has a first fixing portion 411 fixed in the sidewall 113, a first stretch portion 412 upwardly extending from the first fixing portion 411 and received in the groove 1133, a first mating portion 413 upwardly extending from first stretch portion 412 and into the receiving cavity 1120 and a first touching portion 414 further upwardly extending from the first mating portion 413. The first touching portion 414 and the metallic cover 2 together form a switch to detect whether the electrical card is in a write protect state.

The second detect pin 42 has a second fixing portion 421 fixed in another sidewall 113, a second mating portion 422 horizontally extending from the second fixing portion 421 and into the receiving cavity 1120 and a second touching portion 423 upwardly extending from the second fixing portion 421 and received in the notch 1134. The second mating portion 422 is behind the free end 325 of the second contact 32 in the right, the touching portion 423 touches the elastic arm 212 of the lower cover 21. When the electrical card is inserted, the free end 325 of the second contact 32 deflect rearward and electrically contact with the second mating portion 422 of the second detect pin 42, so the second detect pin 42 and the second contact 32 in the right form a detection switch. The additional contacts 4 further has a strength contact 43, which is received in another groove 1133 and has an elastic/engaging portion 431 extending into the receiving cavity 1120 to enhance an insertion/withdraw force of the electrical card.

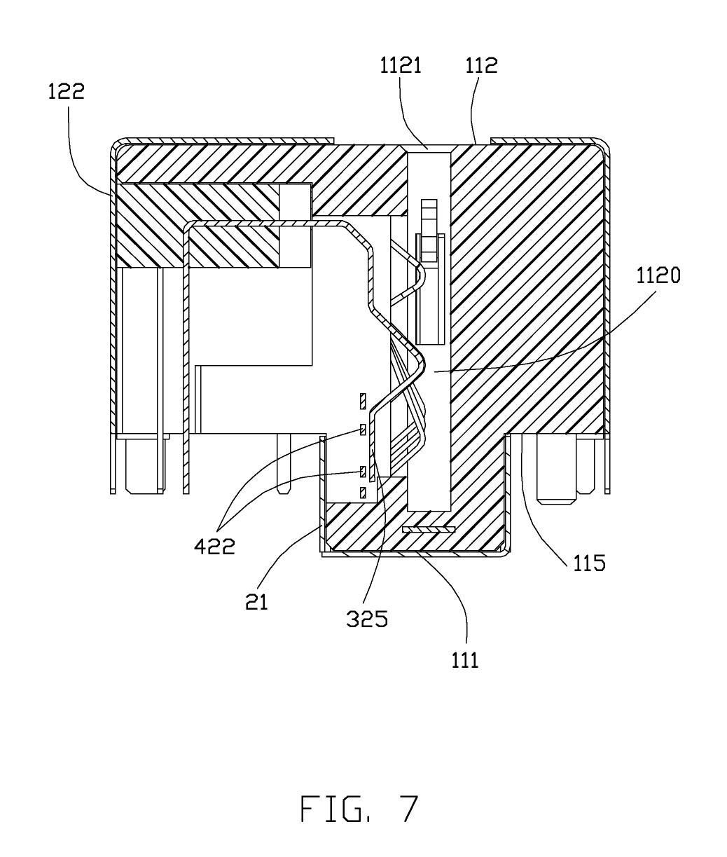

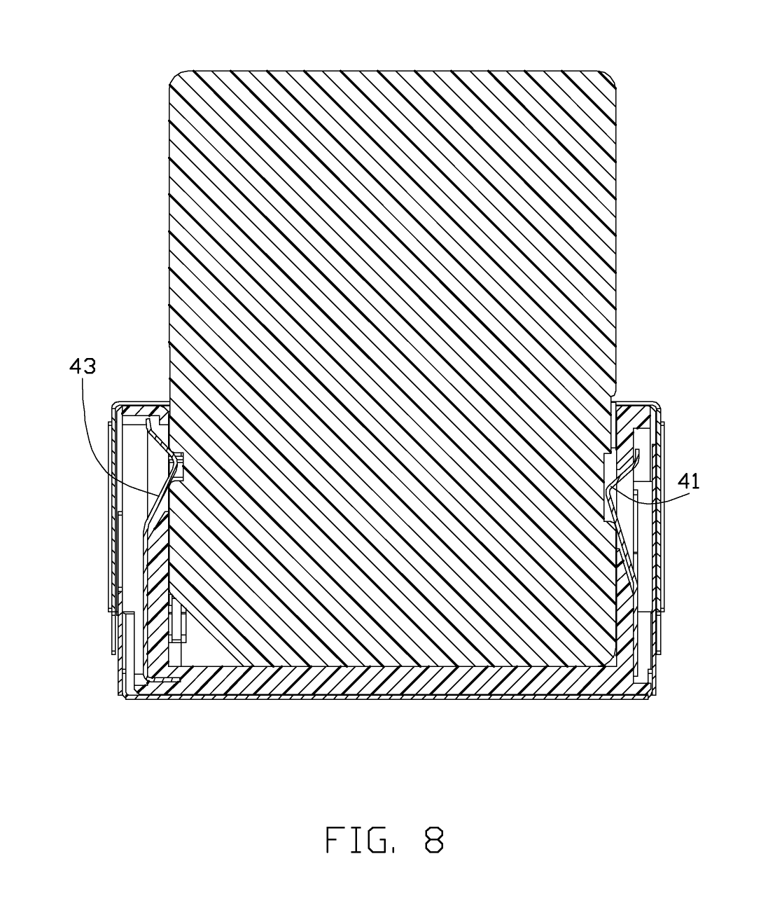

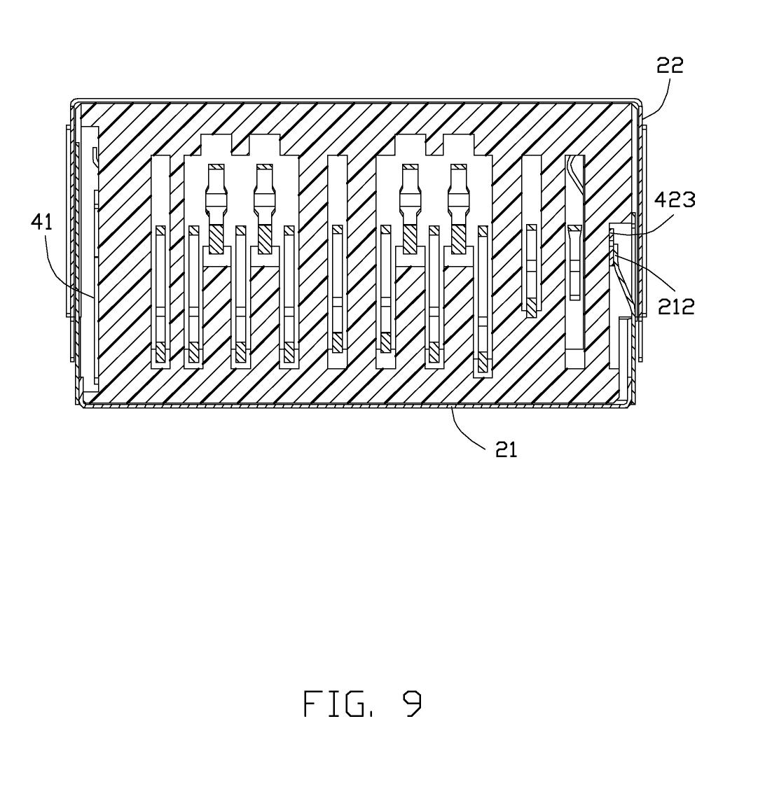

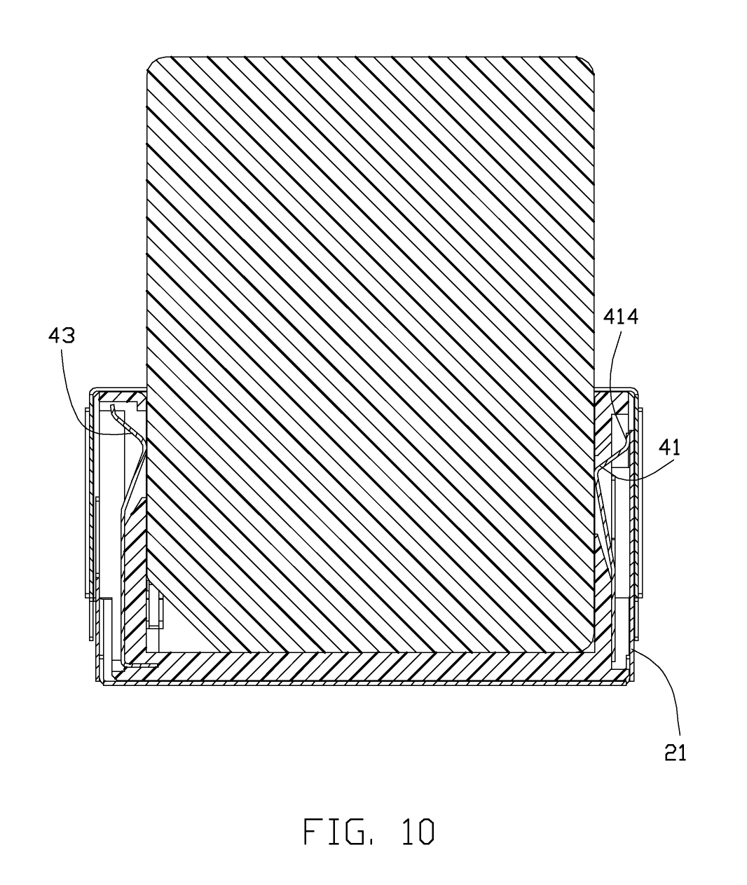

Referring to FIG. 7, as mentioned before, the free end 325 of the second contact 32 moves rearwardly to contact the second mating portion 422 of the second detect pin 42. FIG. 8 shows the additional contacts 41 and 43 are engaged within corresponding notches of one type electrical card. FIG. 9 shows the second touch portion 423 of the second detect pin contacts the elastic arm 212 of the lower cover 21. FIG. 10 shows another type card without the side notches is received in the connector so as to have the touch portion 414 of the detect pin 41 contacts the lower cover 21. Understandably, the card with the side notches may also have the detect pin 41 contact the lower cover 21 at the initial stage of mating before the detect pin 41 is received in the corresponding side notch of the electrical card.

It is to be understood, however, that even though numerous characteristics and advantages of the present invention have been set fourth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A card connector, adapted for electrically connecting an electrical card, comprises:
an insulative housing, the insulative housing defining a top wall and a receiving cavity with an opening in the top wall, a bottom wall opposite to the top wall, two sidewalls, a rear wall, a front wall and a linking wall disposed between the front wall and the rear wall and connecting the top wall and the bottom wall, and the front wall, the bottom wall, the two sidewalls and the linking wall cooperatively defining the receiving cavity;
a plurality of contacts disposed in the housing with corresponding contact portions extending into the receiving cavity;
a metallic shell enclosing the housing to cover the side walls; and
a detect pin located around one corresponding side wall with a mating portion extending into the receiving cavity for engagement within a notch of one type inserted electronic card, and with a touch portion to contact the shell when another type inserted electronic card without corresponding side notches is received in the receiving cavity.

2. The card connector as claimed in claim 1, wherein a contact modular assembled within the insulative housing, the contact modular includes an insulative mass and the retaining portions of the contacts are insert-molded to the insulative mass.

3. The card connector as claimed in claim 2, wherein the insulative mass defines a top face, a bottom face, a front face and a rear face, the insulative mass has a plurality of gaps backwardly recessed from the front face and passing through the top face and the bottom face, and the extending portions of the contacts are exposed in the gaps.

4. The card connector as claimed in claim 1, wherein each of the contacts is formed with an immoveable retaining portion, an extending portion forwardly extending from the retaining portion, an oblique connecting portion forwardly extending from the extending portion, a floating portion downwardly from the connecting portion and an arch contacting portion further downwardly extending from the floating portion; spaced first and second bending points being defined between linking portions of the connecting portion with the floating portion and the extending portion, respectively; wherein
the floating portion is able to deflect about the first and the second bending points in turn when the contacting portion is pressed.

5. The card connector as claimed in claim 1, wherein the linking wall has a plurality of slots, which pass through the linking wall from the rear to front and communicate with the receiving cavity, and the first and the second floating portions are received in the slots.

6. A card connector for use with an electronic card, comprising:
an insulative housing defining opposite mating and mounting faces in a vertical direction, and a receiving cavity upwardly communicating with an exterior in said vertical direction for receiving the electronic card;
a plurality of receiving slots side by side arranged with one another along a longitudinal direction perpendicular to said vertical direction, each of said receiving slots communicating with the receiving cavity in a transverse direction perpendicular to both said vertical direction and said longitudinal direction; and
a plurality of contacts essentially assembled into the housing in the transverse direction and disposed in the corresponding receiving slots, respectively, each of said contacts including a flexible contacting section extending into the receiving cavity and deflectable in said transverse direction; wherein
said housing further defines a bottom face lower than the mounting face so as to have the receiving cavity downwardly extends below the mounting face in the vertical direction.

7. The card connector as claimed in claim 6, further including an upper metallic shell surrounding an upper portion of the housing above the mounting face and below the mating face, and a lower metallic shell surrounding a lower portion of the housing below the mounting face and above the bottom face.

8. The card connector as claimed in claim 7, further including a detecting contact located around a longitudinal end of the housing in said longitudinal direction with a first portion constantly mechanically and electrically connected to the one of the upper metallic shell and the lower metallic shell, and a second portion mechanically and electrically connected to an outermost one of said contacts in said longitudinal direction only when the electronic card is inserted into the receiving cavity.

9. The card connector as claimed in claim 8, wherein said first portion is mechanically and electrically connected to the corresponding shell in the longitudinal direction while the second portion is mechanically and electrically connected to the outermost contact in the transverse direction.

10. The card connector as claimed in claim 8, wherein the housing and the detecting contact are configured to have said detecting contact assembled to the housing in said longitudinal direction.

11. The card connector as claimed in claim 6, further including a detect contact located around a longitudinal end of the housing in said longitudinal direction with a portion which extends into the receiving cavity and is located at a height for locking into a corresponding notch of a first type electronic card or mechanically and electrically connecting to one of said upper metallic shell and the lower metallic shell when mated with a second type electronic card without notches therein.

12. The card connector as claimed in claim 11, wherein the housing and the detecting contact are configured to have said detecting contact assembled to the housing in said longitudinal direction.

13. The card connector as claimed in claim 6, wherein said contacts are integrally formed within an insulative mass to form a contact module, and the housing and the contact module are configured to have said contact module assembled into the housing in the transverse direction.

14. The card connector as claimed in claim 13, wherein said housing forms an assembling room to receive the insulative mass therein.

15. A card connector, adapted for electrically connecting an electrical card, comprising:
an insulative housing;
a metallic cover covering the insulative housing; and
a plurality of contacts received in the insulative housing, the contacts having a first contact group with a plurality of first contacts, the first contact having a first retaining portion, a first extending portion horizontally and forwardly extending from the first retaining portion, a first connecting portion downwardly and forwardly aslant extending from the first extending portion, a first floating portion downwardly from the first connecting portion and a first contacting portion further downwardly extending from the first floating portion; the first contacting portion formed with a forwardly protruding arch shape; a first bending point being defined on a linking portion of the first floating portion and the first connecting portion, and a second bending point being defined on another linking portion of the first connecting portion and the first extending portion, when the first contacting portion is pushed backwardly, the first floating portion deflecting about the first and the second bending point in turn.

16. The card connector as claimed in claim 15, wherein the contacts have a second contact group with a plurality of second contacts, the second contact comprises a second retaining portion, a second extending portion horizontally and forwardly extending from the second retaining portion, a second connecting portion downwardly and forwardly aslant extending from the second extending portion, a second floating portion and downwardly from the second connecting portion and a second contacting portion further downwardly extending from the second floating portion, the second contacting portion is also formed with a forwardly protruding arch shape and below the first contacting portion.

17. The card connector as claimed in claim 16, wherein a third bending point is defined on a linking portion linking the second floating portion and the second connecting portion, and a fourth bending point is defined on a linking portion linking the second connecting portion and the second extending portion, when the second contacting portion is pushed backwardly, the second floating portion deflects about the third and the fourth bending points in turn.

18. The card connector as claimed in claim 17, wherein the insulative housing define a top wall and a receiving cavity, the receiving cavity defines an opening on the top wall for the electrical card inserting, the first and the second contacting portions are exposed in the receiving cavity.

19. The card connector as claimed in claim 17, wherein the insulative housing has a bottom wall, a top wall opposite to the bottom wall, two sidewalls, a rear wall, a front wall and a linking wall disposed between the front wall and the rear wall and connecting the top wall and the bottom wall, and the front wall, the bottom wall, the two sidewalls and the linking wall cooperatively define the receiving cavity.

20. The card connector as claimed in claim 16, wherein the linking wall has a plurality of slots, which pass through the linking wall from the rear to front and communicate with the receiving cavity, the first and the second floating portions are received in the slots.
